(19) United States
(12) Patent Application Publication
(10) Pub. No.: US 2024/0241839 A1
(43) Pub. Date: Jul. 18, 2024

(54) METHODS AND APPARATUS FOR EXTERNAL DISPLAY POWER LOSS DETECTION AND SLEEP STATE RECOVERY

(71) Applicant: Intel Corporation, Santa Clara, CA (US)

(72) Inventors: Anil kumar Nama, Bengaluru (IN); Usha, Bengaluru (IN); Kunal Ashwinkumar Shah, Bengaluru (IN); Manjunatha B M, Bengaluru (IN); Varsha Vithal Baikar, Bengaluru (IN); Shailendra Singh Chauhan, Bengaluru (IN); Muhammed Naseef Murikkumkadan, Kalikavu (IN)

(21) Appl. No.: 18/620,523

(22) Filed: Mar. 28, 2024

(51) Int. Cl. G06F 13/10; G06F 3/14; G06F 3/147; G06F 9/4401

(52) U.S. Cl. CPC G06F 13/10; G06F 9/4418; G06F 3/1423; G06F 3/147

(57) ABSTRACT

Systems, apparatus, articles of manufacture, and methods for external display power loss detection and sleep state recovery are disclosed. Example apparatus disclosed herein include first circuitry to set an output of the first circuitry to a first logic value after a determination that a compute device is to enter a sleep state, and set the output to a second logic value after a determination that the compute device is to exit the sleep state. Disclosed example apparatus also include second circuitry to switch control of a hot plug detect (HPD) input of high-definition multimedia interface (HDMI) circuitry between an output of power loss sensing circuitry and an HPD line of an HDMI port of the HDMI circuitry based on the output of the first circuitry.

### FIELD OF THE DISCLOSURE

This disclosure relates generally to operation of external display devices and, more particularly, to methods and apparatus for external display power loss detection and sleep state recovery.

### BACKGROUND

In recent years, the use of external displays with compute devices to extend and/or render application windows to a secondary display has grown in popularity. For example, users can couple an external display to a compute device with a high-definition multimedia interface (HDMI) connection. Users can then configure an internal display of the compute device and the external display to operate as primary and second displays. In some such examples, users can then choose to mirror their primary and secondary displays, or selectively move, extend, etc., one or more application windows from the primary display to the secondary display, thereby achieving a level of convenience that is adaptable to personal preferences.

### BRIEF DESCRIPTION OF THE DRAWINGS

FIG. 1 is a block diagram of an example compute system including example display state detection circuitry that implements external display power loss detection and sleep state recovery in accordance with teachings of this disclosure.

FIG. 2 illustrates an example sequence diagram illustrating example operation of the display state detection circuitry of FIG. 1.

FIGS. 3-4 are flowcharts representative of example machine readable instructions and/or example operations that may be executed, instantiated, and/or performed by example programmable circuitry to implement the display state detection circuitry of FIG. 1.

FIG. 5 is a block diagram of an example processing platform including programmable circuitry structured to execute, instantiate, and/or perform the example machine readable instructions and/or perform the example operations of FIGS. 3-4 to implement the display state detection circuitry of FIG. 1.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Although battery-powered compute devices such as, for example, laptops, tablets, etc., include a primary display, such battery-powered compute devices are often employed with secondary external display devices, also referred to herein as secondary external displays, secondary displays, external displays, external monitors, etc. With such arrangements, users can choose to mirror a primary display of the battery-powered source device and the secondary external display, cause the primary and secondary display to simulate one display such that a user can selectively move, extend, etc., one or more application windows from the primary display to the secondary external display, thereby achieving a level of convenience that is adaptable to personal preference. Battery-powered devices can couple to external displays via any connection including, but not limited to, an HDMI connection, a digital visual interface (DVI) connection, a video graphics array (VGA) connection, etc.

However, external displays are typically not battery powered devices (e.g., do not include a battery). In other words, external displays typically do not include a secondary power source (e.g., a battery or other portable power source) to provide power when power from an outlet (e.g., an alternating current (AC) electrical outlet) is not available. Thus, absent power from an electrical outlet, such external displays cannot receive power and, thus, cannot operate or function. During a power failure, such external displays are non-functional while the battery-powered compute device is able to function or operate by employing energy from the battery (provided that the battery has adequate charge to power the battery-powered compute device). Thus, while battery-powered compute devices can maintain power to their primary displays, the external displays typically lose power during a power failure.

As a result, when an external display operatively coupled to a battery-powered compute device experiences a power failure (e.g., an AC power failure) without notice to the battery-powered compute device, access to the one or more application windows that have been moved or extended to the secondary external display can be lost until the external display regains power because the battery powered compute device may be unaware that the external display has lost power. Moreover, external displays can serve as primary displays in some compute device configurations. In such configurations, during a power failure at the external display, one or more applications of the compute device, and/or even an operating system of the compute device, may become inaccessible and, thus, inoperable. In some scenarios, a user is inconvenienced to manually recover the extended application windows (e.g., by manually updating a setting to assign the internal display of the source device as the primary display and/or discontinue minoring to the external device, etc.).

HDMI supports hot plug detection (HPD) to enable an HDMI source device, such as a compute device, to detect that an HDMI sink device, such as an external display, has been connected to it based on voltage applied to an HPD line of the HDMI port. However, HPD can be unreliable in instances where battery-powered source devices are connected to external displays. In scenarios in which a battery-powered source device is connected to an external display, the battery of the source device can provide power to the external display via the HDMI connection. As such, an external display may receive a source voltage (e.g., 5 volts) through the HDMI connection, which may be sufficient to provide power to some of the HDMI circuitry of the external device, but is insufficient to otherwise power the external device completely. However, this source voltage provided by the source compute device via the HDMI connection can be sufficient to cause the HPD line to remain asserted after the external display loses power. As a result, after the external display loses power, the source compute device may erroneously detect that the external display is connected to power and, thus, continue to route applications and/or windows to the external display for display or presentation.

In other words, the external display, despite no longer receiving power from the electrical outlet, may still register as operational by the battery-powered computed device by way of a voltage provided by the battery of the compute device across the HDMI connection between the compute device and the external display. Although the detected voltage across the connection between the devices is insufficient to provide power to operate the external display, the measured voltage is sufficient to register the external display as operational with the source compute device. Thus, the source compute device may attempt to display application window(s) on the external display despite the external display having lost power (e.g., the external display being in a non-functional state). As a result, existing approaches that utilize HPD to detect the presence of an external HDMI display device run the risk of failing to detect that an external display has lost connection under scenarios in which the external display is connected to a battery-powered source compute device.

In contrast, example external display power loss detection techniques disclosed herein combine HPD with power loss sensing circuitry that monitors one or more lines of the HDMI connection other than the HPD line to detect external display power loss and also support sleep state recovery. For example, some external display power loss detection techniques disclosed herein utilize power loss sensing circuitry that monitors one or more transmit lines of the HDMI connection between the source compute device and the external display to detect whether the external display experiences a power loss while the source compute device is operating in an active state. In examples disclosed herein, the power loss sensing circuitry is not susceptible to the unreliability associated with HPD when used with battery powered source compute devices. However, while the source compute device is operating in a sleep state or transitioning from the sleep state to the active state, some external display power loss detection techniques disclosed herein utilize HPD to detect whether an external HDMI display is present on the HDMI connection. The use of HPD during the sleep state and the transition from the sleep state to the active state avoids potential race conditions that can affect the ability of some external devices to wake from their own low power states, as described in further detail below.

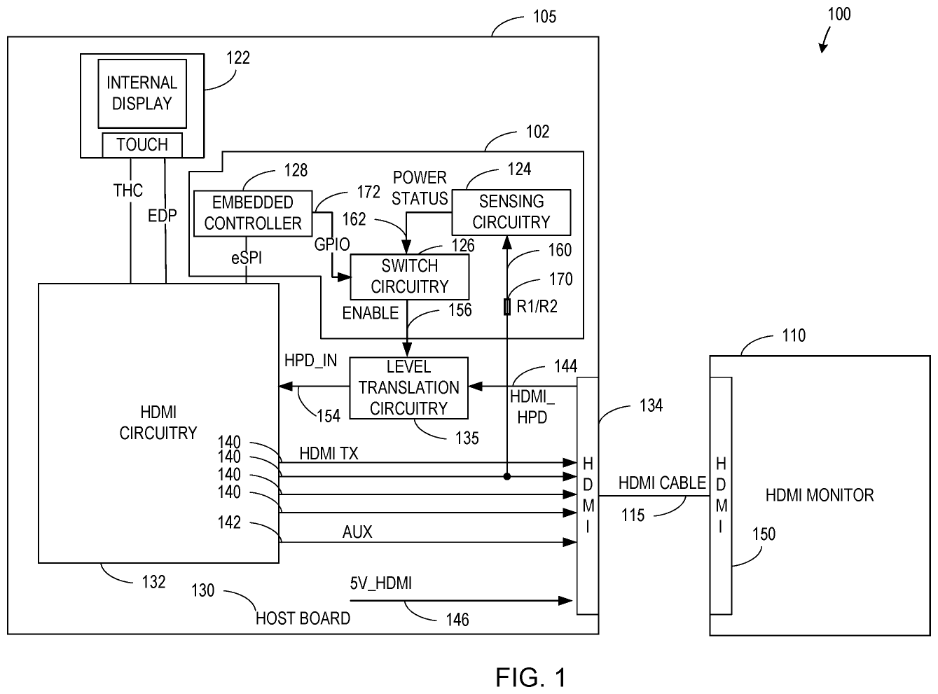

FIG. 1 is a block diagram of an example compute system 100 that includes example display state detection circuitry 102 that implements external display power loss detection and sleep state recovery in accordance with teachings of this disclosure. The display state detection circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the display state detection circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example compute system 100 of FIG. 1 includes an example source compute device 105 (e.g., a laptop) coupled to an example external display 110 (e.g., a computer monitor, an external display) via an example connection 115 (e.g., a connection cable, a wired connection, etc.). The source compute device 105 of the illustrated example is a battery-powered device and includes an example battery 120 (e.g., a rechargeable battery). In the illustrated example, the source compute device 105 includes an example internal display 122, which may be a source display, a liquid crystal display (LCD) display, a light emitting diode (LED) display, a touch screen display, etc., and is also referred to as the first display 122. The external display 110, which may be an LCD display, an LED display, a touchscreen display, etc., is also referred to as the second display 110. In some examples, the internal display 122 of the compute device 105 can be employed as a primary display and the external display 110 can be employed as a secondary display. In some examples, the external display 110 can be employed as a primary display and the internal display 122 of the source compute device 105 can be employed as a secondary display.

The example connection 115 of the illustrated example is an HDMI connection 115 (e.g., an HDMI cable). While the example of FIG. 1 communicatively couples the source compute device 105 and the external display 110 via the HDMI connection 115, in some examples any one or more connections may be utilized. For example, the connection 115 between the source compute device 105 and the external display 110 may be implemented by any other connection including, but not limited to, a video graphics array (VGA) connection, digital visual interface (DVI) connection, DisplayPort connection, a universal serial bus (USB) Type-C connection, etc., and/or any other connection or cable for communicatively coupling two or more electronic devices.

The display state detection circuitry 102 of the illustrated example implements external display power loss detection and sleep state recovery in accordance with teachings of this disclosure. As disclosed in further detail below, the display state detection circuitry 102 includes example power loss sensing circuitry 124 to monitor the HDMI connection 115 to detect a power loss associated with the external display 110 while the source compute device 105 is operating in an active state. The display state detection circuitry 102 of the illustrated example also includes example switch circuitry 126 and example embedded controller circuitry 128 to facilitate detecting the presence of the external display 110 while the source compute device 105 is operating in a sleep state or transitioning from the sleep state to the active state. As disclosed in further detail below, inclusion of the switch circuitry 126 and the embedded controller circuitry 128 in the display state detection circuitry 102 helps avoids potential race conditions that can affect the ability of some external displays 110 to properly wake from their own low power states.

The source compute device 105 of the illustrated example can be any battery-powered device that is capable of connecting to an external display device, such as the external display 110, using an HDMI connection, such as the HDMI connection 115 and/or a similar connection. In examples disclosed herein, the source computer device 105 is represented as a laptop. However, in some examples, any other type of battery powered device (e.g., a mobile phone, tablet, etc.) can be utilized in conjunction with the example display state detection circuitry 102 for external display power loss detection.

The external display 110 of the illustrated example can be any display device that is capable of connecting to a source compute device, such as the source compute device 105, using an HDMI connection, such as the HDMI connection 115 and/or a similar connection. In examples disclosed herein, the external display 110 is a computer monitor. However, in some examples, any other type of external display (e.g., an LCD screen, tablet, etc.) may be utilized in conjunction with the example display state detection circuitry 102 for external display power loss detection. Furthermore, although the external display 110 shown in the example FIG. 1 is a single display, in some examples, a plurality of external displays and/or other external devices (e.g., multiple computer monitors) can operatively couple to the source compute device 105 (e.g., contemporaneously).

The source compute device 105 of the illustrated example includes electronic components that provide instructions and/or signals to display information, applications, windows and/or other graphics via the internal display 122 and the external display 110. The electronic components include, but are not limited to, an example printed circuit board (PCB) 130 (e.g., also referred to as a host board), example HDMI circuitry 132 (e.g., implemented by one or more system-on-a-chip (SoC) devices, field programmable gate arrays (FPGAs), etc.), a first example HDMI connector 134 (e.g., an input/output connector, an input/output port, etc.), and example level translation circuitry 135. The HDMI circuitry 132 communicates (e.g., sends and/or receives) information (e.g., signals) with the first HDMI connector 134 via a set of HDMI lines, also referred to as HDMI channels. The HDMI lines of the illustrated example include a set of HDMI transmit (TX) lines/channels 140, an HDMI auxiliary (AUX) line/channel 142, and an HDMI HPD (HDMI_HPD) line/channel 144. The source compute device 105 also includes an example power supply line 146 (e.g., a 5 volt power line) that provides power to the HDMI connection 115 (e.g., via the first HDMI connector 134). The HDMI TX channels 140 serve as generalized communication channels between the source compute device 105 and the external display 110 for sending and/or receiving data, external display status queries, etc.

The external display 110 of the illustrated example includes a second example HDMI connector 150 (e.g., an input/output connector, an input/output port, etc.) to communicatively couple to the source compute device 105. For example, the HDMI connection 115 (cable) communicatively couples the source compute device 105 and the external display 110 such that the HDMI circuitry 132 of the source compute device 105 instructs, commands, or otherwise causes the external display 110 to display one or more applications, programs, graphics, etc., via the HDMI connection 115.

The HDMI circuitry 132 commands and/or provides instructions to the internal display 122 of the source compute device 105 and to the external display 110. For example, the HDMI circuitry 132 employs the HDMI connection 115 to communicate information, command(s), signal(s), etc., between the source compute device 105 and the external display 110. In the illustrated example, HDMI circuitry 132 communicates commands or signals to the first HDMI connector 134, and the first HDMI connector 134 transmits the commands and/or signals to the second HDMI connector 150 of the external display 110 via the HDMI connection 115. In turn, the external display 110 communicates signals to the HDMI circuitry 132 of the source compute device 105 via the HDMI connection 115.

For example, the HDMI circuitry 132 receives input from the HDMI_HDP line 144 of the first HDMI connector 134 coupled to the HDMI connection 115. The HDMI circuitry 132 also provides auxiliary data to the external display 110 using the HDMI AUX line 142 of the first HDMI connector 134 coupled to the HDMI connection 115. The HDMI_HPD line 144 provides an HPD signal employed by the source compute device 105 to detect a physical connection with the external display 110. The HDMI AUX line 142 is used by the HDMI circuitry 132 to query a status of the external display 110 when a potential power loss event has been detected by the display state detection circuitry 102. For example, the HDMI circuitry 132 sends a signal across the HDMI AUX line 142 to the external display 110 and determines whether the external display 110 provides a response to a signal propagated by the source compute device 105 to the external display 110. If the external display 110 does not respond, the source compute device 105 sets a status of the external display 110 as “not responding”. If the external display 110 responds, the source device 105 sets a status of the external display 110 as “responding.”

The source compute device 105 includes the level translation circuitry 135 to translate a voltage range of the HDMI_HDP line 144 to a voltage range that can be input to an example HPD input line 154 (e.g., the HPD_IN line 154) of the HDMI circuitry 132. As such, the level translation circuitry 135 has an input to couple to the HDMI_HDP line 144 and an output to couple to the HPD input line 154. For example, the HDMI_HDP line 144 may have a range of 0 to 5 volts (V), with a voltage satisfying (e.g., meeting or exceeding) a threshold in that range corresponding to a first logic value (e.g., a logic-1 value), and a voltage not satisfying (e.g., less than) the threshold corresponding to a second logic value (e.g., a logic-0 value). The level translation circuitry 135 of the illustrated example translates the 0 to 5 v range of the HDMI_HDP line 144 to a smaller voltage range, such as 0 to 3.3 V or 0 to 1.8 V, etc., supported by the HPD_IN line 154, with a voltage satisfying (e.g., meeting or exceeding) a threshold in that range corresponding to a first logic value (e.g., a logic-1 value), and a voltage not satisfying (e.g., less than) the threshold corresponding to a second logic value (e.g., a logic-0 value).

In some examples, the HDMI_HDP line 144 and the HPD_IN line 154 have a voltage value corresponding to the first logic value (e.g., a logic-1 value) when the external display 110 is powered and connected to the compute device 105 via the HDMI connection 115. Conversely, in some such examples, the HDMI_HDP line 144 and the HPD_IN line 154 have a voltage value corresponding to the second logic value (e.g., a logic-0 value) when the external display 110 is unpowered (e.g., power is lost) or disconnected from the HDMI connection 115. In the illustrated example, the level translation circuitry 135 also has an example enable input 156 to enable (e.g., activate) or disable (e.g., deactivate) the level translation circuitry 135. For example, when the enable input 156 is asserted or, in other words, has a voltage value set to the first logic value (e.g., a logic-1 value), the level translation circuitry 135 is enabled and the logic value of the HDMI_HDP line 144 controls the logic value of the HPD_IN line 154. However, when the enable input 156 is not asserted or, in other words, has a voltage value set to the second logic value (e.g., a logic-0 value), the level translation circuitry 135 is disabled and the value of the HDMI_HDP line 144 defaults to 0 volts (e.g., within a tolerance), which corresponds to the second logic value (e.g., a logic-0 value).

As described above, in some scenarios in which a battery-powered source device, such as the compute device 105, is connected to an external display, such as the external display 110, the battery 120 of the source compute device 105 can provide power to the external display 110 via the HDMI connection 115. For example, the external display 110 may receive a source voltage (e.g., 5 volts) through the HDMI connection 115 via the power supply line 146 coupled to the first HDMI connector 134. The power supply line 146 may be sufficient to provide power to some of the HDMI circuitry of the external device 110, but is typically insufficient to otherwise power the external device 110 completely. However, this source voltage provided by the power supply line 146 of source compute device 105 via the HDMI connection 115 can be sufficient to cause the HDMI HPD line 144 to remain asserted after the external display 110 loses power. As a result, absent the display state detection circuitry 102 described in further detail below, after the external display 110 loses power, the HDMI circuitry 132 of the source compute device 105 could erroneously detect that the external display 110 is connected to power and, thus, continue to route applications and/or windows to the external display 110 for display or presentation.

Fortunately, the source compute device 105 of the illustrated example includes the display state detection circuitry 102 to mitigate the effects of the power supply line 146 on HPD operation and provide accurate detection of power loss associated with the external display 110. The display state detection circuitry 102 includes the power loss sensing circuitry 124 to monitor the HDMI connection 115 to detect a power loss associated with the external display 110 while the source compute device 105 is operating in an active state. In the illustrated example, the power loss sensing circuitry 124 of FIG. 1 is located inside a housing of the source compute device 105. For example, the power loss sensing circuitry 124 is supported by the PCB 130 (e.g., the host board) of the source compute device 105 and is operatively and/or electrically coupled to one or more of the HDMI transmit lines 140. Thus, the power loss sensing circuitry 124 of the illustrated example is operatively coupled to the external display 110 via the one or more HDMI transmit lines 140 of the HDMI connection 115 when the HDMI cable is coupled to the first HDMI connector 134 and the second HDMI connector 150.

The power loss sensing circuitry 124 of the illustrated example monitors for activity on one or more HDMI transmit lines 140 of the HDMI connector 134 (and, thus, of the HDMI connection 115) to detect a potential power loss of the external display 110. For example, the power loss sensing circuitry 124 has an example sensing input 160 that is electrically or operatively coupled to one or more of the HDMI transmit line(s) 140 to receive voltage value(s) from the HDMI transmit line(s) 140. The power loss sensing circuitry 124 further has an example power status output 162 to indicate whether the external display 110 has experienced a power loss. For example, the power loss sensing circuitry 124 sets the power status output 162 to a first voltage value (e.g., 5 V, 3.3 V, 1.8 V) corresponding to a first logic value (e.g., a logic-1 value) if the voltage value(s) from the HDMI transmit line(s) 140 indicate the external display 110 is powered. Conversely, the power loss sensing circuitry 124 sets the power status output 162 to a second voltage value (e.g., 0 V) corresponding to a second logic value (e.g., a logic-0 value) if the voltage value(s) from the HDMI transmit line(s) 140 indicate the external display 110 has experienced a power loss.

In some examples, the power loss sensing circuitry 124 determines the external display 110 is powered if the received voltage at the sensing input 160 from the HDMI transmit line(s) 140 satisfies (e.g., meets or exceeds) a threshold to indicate data is being transmitted between the source compute device 105 and the external device 110 via the HDMI connection 115. In some such examples, the power loss sensing circuitry 124 continues to determine the external display 110 is powered so long as the received voltage at the sensing input 160 from the HDMI transmit line(s) 140 does not remain below the threshold for longer than a transmission timeout period or some other duration. However, in some such examples, if the received voltage at the sensing input 160 from the HDMI transmit line(s) 140 does not satisfy (e.g., remains below) the threshold for longer than the transmission timeout period or other duration, then the power loss sensing circuitry 124 determines the external display 110 has experienced a power loss (e.g., as exhibited by the inactivity of the HDMI transmit line(s) 140).

The power loss sensing circuitry 124 of the illustrated example also includes an example filter 170 (e.g., a resistor R1/R2 component) that filters the physical connection characteristic (e.g., voltage value) from the HDMI transmit line(s) 140. The filtered physical connection characteristic is then provided to the power loss sensing circuitry 124 via the sensing input 160 (e.g., as filtered input signal) for monitoring and/or evaluation. Further examples of the power loss sensing circuitry 124 and the filter 170 are described in U.S. Patent Publication No. 2022/0107773, which was published on Apr. 7, 2022.

As described above, the display state detection circuitry 102 of the illustrated example also includes the switch circuitry 126 and the embedded controller circuitry 128 to facilitate detecting the presence of the external display 110 while the source compute device 105 is operating in a sleep state or transitioning from the sleep state to the active state. The inclusion of the switch circuitry 126 and the embedded controller circuitry 128 in the display state detection circuitry 102 helps avoids potential race conditions that can affect the ability of some external displays 110 to properly wake from their own low power states.

For example, when the source compute device 105 enters a sleep state, the source compute device 105 may turn off the power supply line 146 providing power to the HDMI connection 115 (e.g., via the first HDMI connector 134). In response, some external displays 110 detect that loss of power on the HDMI connection 115 (e.g., via the second HDMI connector 150) and enter their own low power states. Furthermore, some such external displays 110 may not wake from their low power states until data is received via the HDMI transmit line(s) 140. When the source compute device 105 exits its sleep state and transitions to active state, the source compute device 105 turns on the power supply line 146 providing power to the HDMI connection 115 (e.g., via the first HDMI connector 134). However, if the source compute device 105 relied solely on the switch circuitry 126 to detect whether such an external device 110 is powered, the switch circuitry 126 would indicate the external display 110 has experienced a power loss because there will not be any activity on the HDMI transmit line(s) 140 until the external device 110 wakes from its low power state. But, that external display 110 will not wake from its low power state until activity is sensed on the HDMI transmit line(s) 140. As such, there is a potential race condition that can prevent such external displays 110 from waking from their low power states.

The switch circuitry 126 and the embedded controller circuitry 128 mitigate/avoid such race conditions by causing the HDMI circuitry 132 to utilize the power loss sensing circuitry 124 to detect the power status and, thus, the presence of the external device 110 while the compute device 105 is operating in an active state. However, while the compute device 105 is operating in a sleep state or transitioning from the sleep state to the active state, the switch circuitry 126 and the embedded controller circuitry 128 cause the compute device 105 to use the HDMI_HPD line 144 to detect the presence of the external device 110.

For example, the switch circuitry 126 has a first input to accept the power status output 162 of the power loss sensing circuitry 124 and a second input to accept an example control output 172 from the embedded controller circuitry 128. The switch circuitry 126 also has an output coupled to the enable input 156 of the level translation circuitry 135 to control the setting of the enable input 156 based on the power status output 162 of the power loss sensing circuitry 124 and the control output 172 from the embedded controller circuitry 128. Furthermore, in the illustrated example, the embedded controller circuitry 128 sets the value of its control output 172 based on the operating state of the source compute device 105 to cause either the power loss sensing circuitry 124 or the HDMI_HPD line 144 to control (e.g., set a value of) the HPD input 154 of the HDMI circuitry 132. As the HDMI circuitry 132 uses the value of the HPD input 154 to detect the presence of the external device 110 (and, thus, whether the external device 110 has exhibited a power loss), the embedded controller circuitry 128 sets the value of its control output 172 to activate or deactivate the ability of the power loss sensing circuitry 124 to control (e.g., set the value of) the HPD input 154 of the HDMI circuitry 132.

In the illustrated example, the embedded controller circuitry 128 sets the control output 172 to a first logic value (e.g., a logic-1 value) when the power loss sensing circuitry 124 is to be activated to control (e.g., set the value of) the HPD input 154 of the HDMI circuitry 132. As such, in the illustrated example, when the control output 172 is set to the first logic value (e.g., a logic-1 value), the switch circuitry 126 switches control of the HPD input 154 of the HDMI circuitry 132 to the power loss sensing circuitry 124 by causing the power status output 162 of the power loss sensing circuitry 124 to control the enable input 156 of the level translation circuitry 135. This works because, when the compute device 105 is in the active state, the power supply line 146 is turned on and the HDMI HPD line 144 of the first HDMI connector 134 will be set to the first logic value (e.g., logic-1). Because the power status output 162 of the power loss sensing circuitry 124 controls the enable input 156 of the level translation circuitry 135 in this example, the logic value of the HPD input 154 of the HDMI circuitry 132 will be set the same as the logic value of the power status output 162 of the power loss sensing circuitry 124 (e.g., the HPD input 154 will be asserted (e.g., a logic-1 value) when the output 162 of the power loss sensing circuitry 124 is asserted (e.g., a logic-1 value) and indicates the external display 110 is powered, and the HPD input 154 will be de-asserted (e.g., a logic-0 value) when the output 162 of the power loss sensing circuitry 124 is de-asserted (e.g., a logic-0 value) and indicates the external display 110 has exhibited a power loss). As such, the power status output 162 of the power loss sensing circuitry 124 controls the enable input 156 of the level translation circuitry 135 when the embedded controller circuitry 128 sets the control output 172 to the first logic value (e.g., a logic-1 value).

Conversely, in the illustrated example, the embedded controller circuitry 128 sets the control output 172 to a second logic value (e.g., a logic-0 value) when the ability of the power loss sensing circuitry 124 to control (e.g., set the value of) the HPD input 154 of the HDMI circuitry 132 is to be deactivated. As such, in the illustrated example, when the control output 172 is set to the second logic value (e.g., a logic-0 value), the switch circuitry 126 asserts (e.g., enables) the enable input 156 of the level translation circuitry 135, which switches control of the HPD input 154 of the HDMI circuitry 132 to the HDMI_HPD line 144. By forcing the enable input 156 of the level translation circuitry 135 to be asserted in this scenario, the power status output 162 of the power loss sensing circuitry 124 is ignored and the logic value of the HPD input 154 of the HDMI circuitry 132 will be set the same as the logic value of the HDMI_HPD line 144 (e.g., the HPD input 154 will be asserted (e.g., a logic-1 value) when the HDMI_HPD line 144 is asserted (e.g., a logic-1 value), and the HPD input 154 will be de-asserted (e.g., a logic-0 value) when the HDMI_HPD line 144 is de-asserted (e.g., a logic-0 value)).

As mentioned above, the embedded controller circuitry 128 sets the value of its control output 172 based on the operating state of the source compute device 105 to cause either the power loss sensing circuitry 124 or the HDMI_HPD line 144 to control (e.g., set the value of) the HPD input 154 of the HDMI circuitry 132. In some examples, the embedded controller circuitry 128 is an embedded controller of the compute device 105, and the control output 172 is an available general purpose input/output (GPIO) pin of the embedded controller. Furthermore, in some examples, the embedded controller is responsible for performing power management of the compute device 105 and, thus, has access to information concerning the operating state of the compute device 105, such as whether the compute device 105 is operating in an active state, a sleep state, etc., or transitioning between such operating states.

In the illustrated example, the embedded controller circuitry 128 sets a value of its control output 172 to a first logic value (e.g., a logic-0 value) after a determination that the compute device 105 is to enter a sleep state. As described above, this value of the control output 172 causes the switch circuitry 126 to switch control of the HPD input 154 of the HDMI circuitry 132 to the HDMI_HPD line 144 in the sleep state by forcing the enable input 156 of the level translation circuitry 135 to be asserted (e.g., enabled). In some examples, the embedded controller circuitry 128 determines that the compute device 105 is to enter a sleep state based on information, such as one or more signals, instructions, register values, etc., obtained from an operating system (OS) of the compute device 105, a basic input output system (BIOS) of the compute device 105, etc., or any combination thereof.

In the illustrated example, the embedded controller circuitry 128 sets a value of its control output 172 to a second logic value (e.g., a logic-1 value) after a determination that the compute device 105 is to exit the sleep state and transition to the active state. As described above, this value of the control output 172 causes the switch circuitry 126 to switch control of the HPD input 154 of the HDMI circuitry 132 to the power loss sensing circuitry 124 in the active state by causing the power status output 162 of the power loss sensing circuitry 124 to control the enable input 156 of the level translation circuitry 135. In some examples, the embedded controller circuitry 128 determines that the compute device 105 is to exit the sleep state based on information, such as one or more signals, instructions, register values, etc., obtained from an operating system (OS) of the compute device 105, a basic input output system (BIOS) of the compute device 105, etc., or any combination thereof. In some examples, after the determination that the compute device 105 is to exit the sleep state and transition to the active state, the embedded controller circuitry 128 monitors for expiration of a time period and waits to set the value of its control output 172 to the second logic value (e.g., a logic-1 value) until after the time period has expired. In some examples, the time period is configurable by the embedded controller circuitry 128 (e.g., based on a BIOS setting, an OS command, etc.). Such a delay can provide time for the HDMI circuitry 132 to detect and enumerate the external display 110, and for the external display 110 to wake from its own low power state, before switching to the power loss sensing circuitry 124 for monitoring the power state and presence of the external display 110.

In examples in which the compute device 105 includes multiple HDMI connectors 134 (e.g., multiple HDMI ports 134), each HDMI connector/port 134 may have its own respective level translation circuitry 135, power loss sensing circuitry 124, filter 170 and switch circuitry 126. However, in some such examples, a single embedded controller 128 and its control output 172 may control operation of some or all of the different switch circuitry 126 of the different HDMI connectors/ports 134.

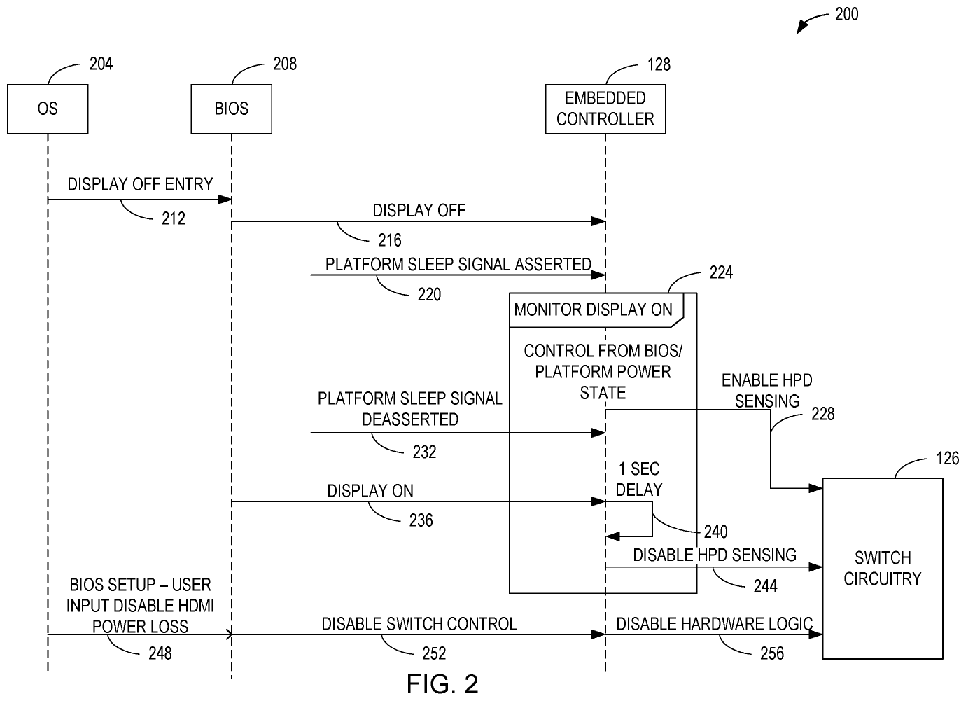

FIG. 2 illustrates an example sequence diagram 200 illustrating example operation of the display state detection circuitry 102 of FIG. 1. The sequence diagram 200 illustrates operation of the embedded controller circuitry 128 based on an example OS 204 and an example BIOS 208 of the compute device 105. In the sequence diagram 200, at example operation 212, the OS 204 informs the BIOS 208 that the external display 110 is to enter a display OFF state, for example, because the compute device is to enter a sleep state. At example operation 216, the BIOS 208 informs the embedded controller circuitry 128 that the external display 110 is to enter the display OFF state. At example 220, the BIOS 208 informs the embedded controller circuitry 128 that the compute device 105 is to enter a sleep state.

At example operation 224, the embedded controller circuitry 128 executes an example procedure to monitor for the external device 110 being power back ON. In the illustrated example, at example operation 228, the embedded controller circuitry 128 initially sets a value of its control output 172 to a first logic value (e.g., a logic-0 value) after the determination that the compute device 105 is to enter the sleep state. This value of the control output 172 causes the switch circuitry 126 to switch control of the HPD input 154 of the HDMI circuitry 132 to the HDMI_HPD line 144 in the sleep state by forcing the enable input 156 of the level translation circuitry 135 to be asserted. At example operation 232, the BIOS 208 informs the embedded controller circuitry 128 that the compute device 105 is to exit the sleep state (e.g., and transition to the active state). At example operation 236, the BIOS 208 informs the embedded controller circuitry 128 that the external display 110 is to enter the display ON state. At example operation 240, the embedded controller circuitry 128 waits a time period (e.g., of 1 second or some other value, which may be configurable). After the determination that the compute device 105 is to exit the sleep state, and after expiration of the time period, at example operation 244 the embedded controller circuitry 128 sets a value of its control output 172 to a second logic value (e.g., a logic-1 value). This value of the control output 172 causes the switch circuitry 126 to switch control of the HPD input 154 of the HDMI circuitry 132 to the power loss sensing circuitry 124 in the active state by causing the power status output 162 of the power loss sensing circuitry 124 to control the enable input 156 of the level translation circuitry 135.

The sequence diagram 200 also illustrates example operations 248, 252 and 258 to disable the use of the power loss sensing circuitry 124 from being able to control the enable input 156 of the level translation circuitry 135. For example, at operation 248, one or more BIOS settings are configured to disable the use of the power loss sensing circuitry 124. At operation 252, the BIOS informs the embedded controller circuitry 128 that the ability of the switch circuitry 126 to switch control of the HPD input 154 of the HDMI circuitry 132 to the power loss sensing circuitry 124 is to be disabled. At operation 256, the embedded controller circuitry 128 sets the value of its control output 172 to the first logic value (e.g., a logic-0 value), which causes the switch circuitry 126 to assert the enable input 156 of the level translation circuitry 135, which causes the HDMI_HPD line 144 to control the HPD input 154 of the HDMI circuitry 132.

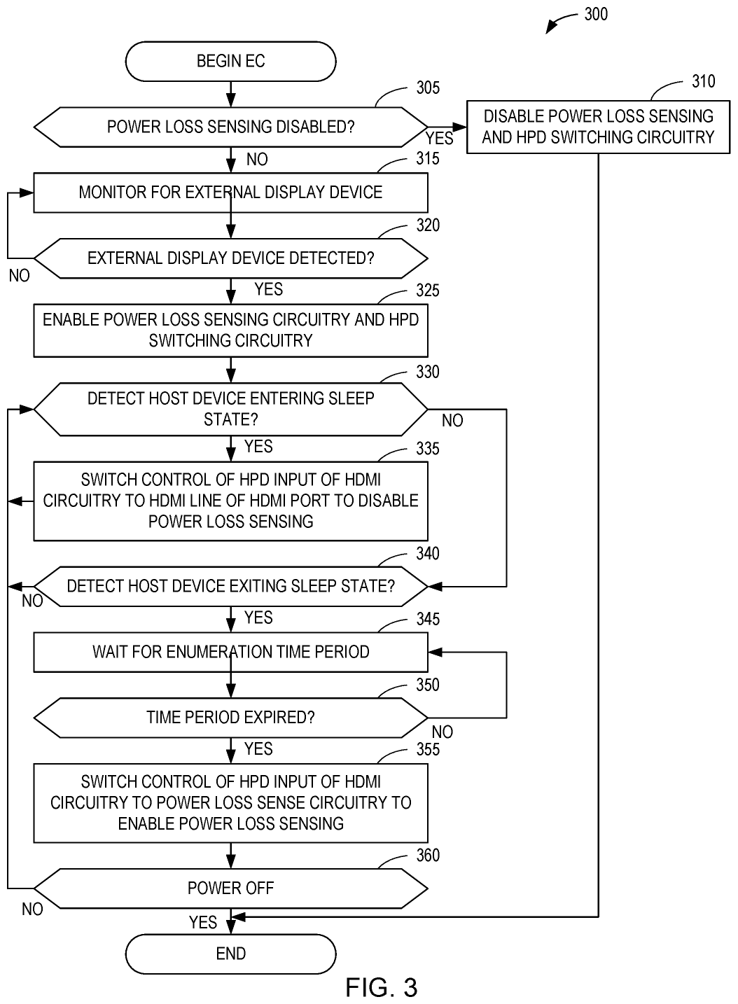

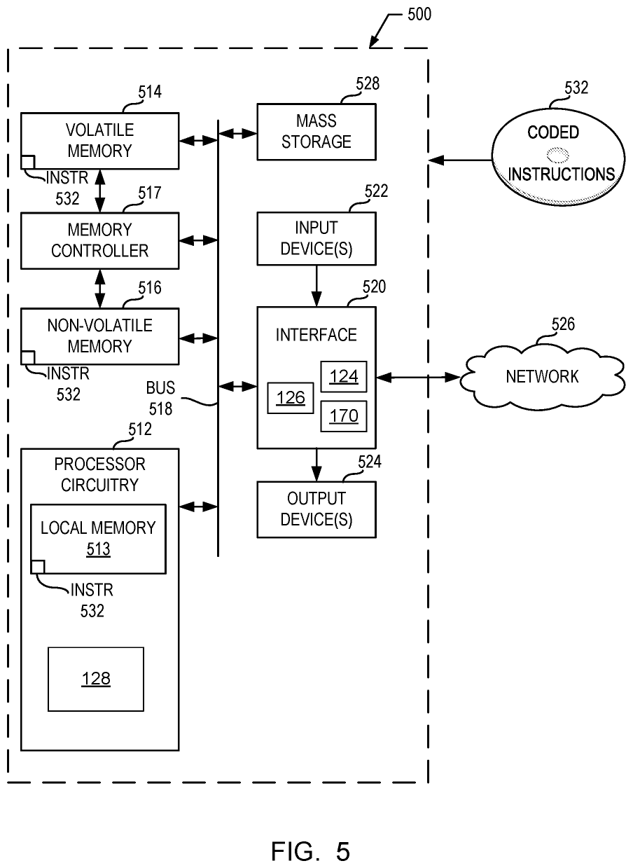

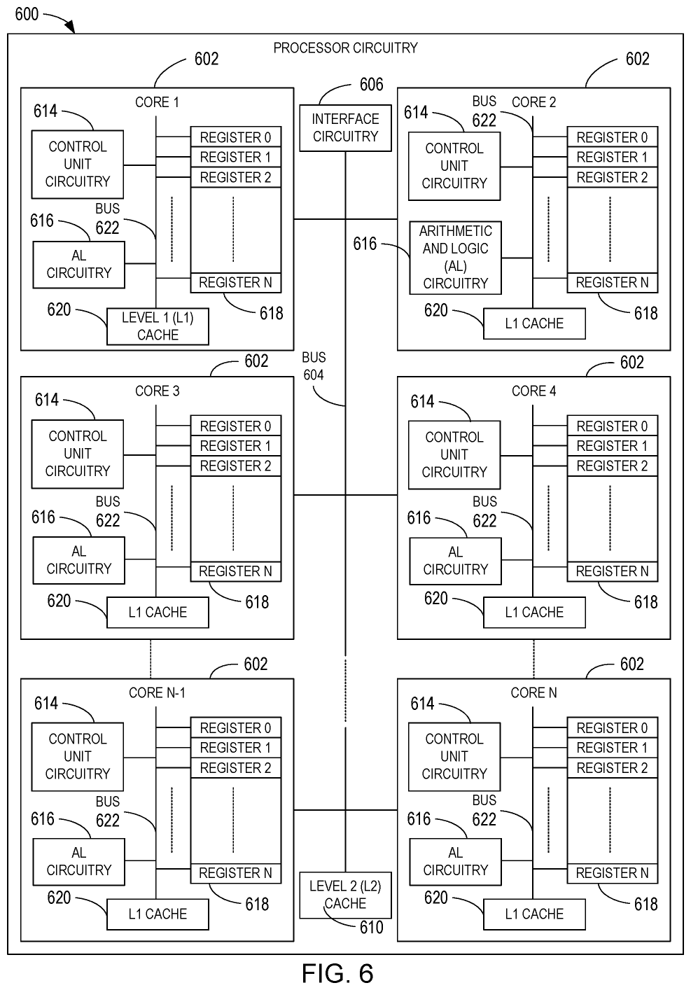

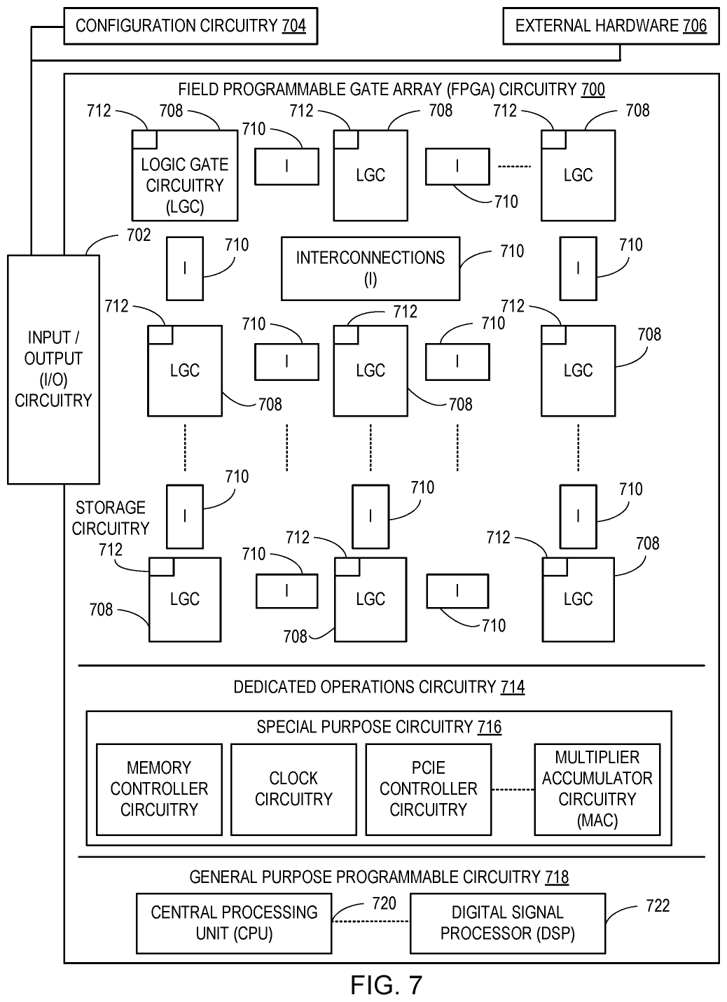

In some examples, the display state detection circuitry 102 includes means for indicating an operating state of a compute device. For example, the means for indicating may be implemented by the embedded controller circuitry 128. In some examples, the embedded controller circuitry 128 may be instantiated by programmable circuitry such as the example programmable circuitry 512 of FIG. 5. For instance, the embedded controller circuitry 128 may be instantiated by the example microprocessor 600 of FIG. 6 executing machine executable instructions such as those implemented by at least the flowchart of FIG. 3. In some examples, the embedded controller circuitry 128 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the embedded controller circuitry 128 may be instantiated by any other combination of hardware, software, and/or firmware. For example, the embedded controller circuitry 128 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

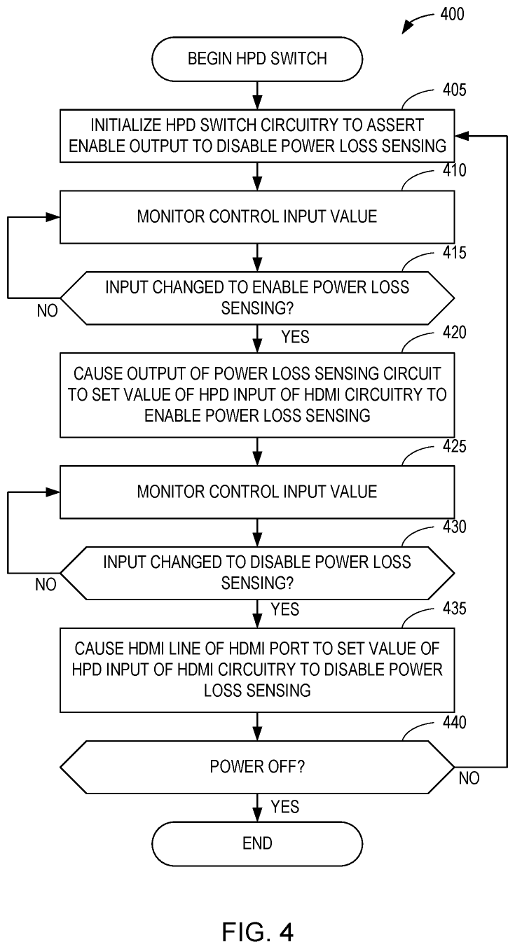

In some examples, the display state detection circuitry 102 includes means for switching control of an HDMI input of HDMI circuitry. For example, the means for switching may be implemented by the switch circuitry 126. In some examples, the switch circuitry 126 may be instantiated by programmable circuitry such as the example programmable circuitry 512 of FIG. 5. For instance, the switch circuitry 126 may be instantiated by the example microprocessor 600 of FIG. 6 executing machine executable instructions such as those implemented by at least the flowchart of FIG. 4. In some examples, the switch circuitry 126 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the switch circuitry 126 may be instantiated by any other combination of hardware, software, and/or firmware. For example, the switch circuitry 126 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compute device 105 is illustrated in FIGS. 1-2, one or more of the elements, processes, and/or devices illustrated in FIGS. 1-2. may be combined, divided, re-arranged, omitted, eliminated, and/or implemented in any other way. Further, the display state detection circuitry 102, the internal display 122, the power loss sensing circuitry 124, the switch circuitry 126, the example embedded controller circuitry 128, the HDMI circuitry 132, the HDMI connector 134, the level translation circuitry 135, the filter 170 and/or, more generally, the example compute device 105, may be implemented by hardware alone or by hardware in combination with software and/or firmware. Thus, for example, any of the display state detection circuitry 102, the internal display 122, the power loss sensing circuitry 124, the switch circuitry 126, the example embedded controller circuitry 128, the HDMI circuitry 132, the HDMI connector 134, the level translation circuitry 135, the filter 170 and/or, more generally, the example compute device 105, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compute device 105 may include one or more elements, processes, and/or devices in addition to, or instead of, those illustrated in FIGS. 1-2, and/or may include more than one of any or all of the illustrated elements, processes and devices.

Flowchart(s) representative of example machine readable instructions, which may be executed by programmable circuitry to implement and/or instantiate the display state detection circuitry 102 of FIGS. 1-2 and/or representative of example operations which may be performed by programmable circuitry to implement and/or instantiate the display state detection circuitry 102 of FIGS. 1-2, are shown in FIGS. 3-4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example display state detection circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, Hypertext Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to implement the example embedded controller circuitry 128 of the display state detection circuitry 102. The example machine-readable instructions and/or the example operations 300 of FIG. 3 begin at block 305, at which the embedded controller circuitry 128 determines whether the use of the power loss sensing circuitry 124 is to be disabled (e.g., based on one or more BIOS settings), as described above. If the use of the power loss sensing circuitry 124 is to be disabled, at block 310 the embedded controller circuitry 128 sets the value of its control output 172 to a first logic value (e.g., a logic-0 value), which causes the switch circuitry 126 to set the enable input 156 of the level translation circuitry 135 to be enabled and allows the HDMI_HPD line 144 to control the HPD input 154 of the HDMI circuitry 132, as described above.

However, if the use of the power loss sensing circuitry 124 is not to be disabled (e.g., is to be enabled), at block 315 the embedded controller circuitry 128 monitors for the presence of the external display device 110. For example, the embedded controller circuitry 128 may receive information (e.g., a signal, an instruction, etc.) from the HDMI circuitry 132 indicating the external display device 110 has been detected (e.g., via the HDMI_HPD line 144 controlling the HPD input 154 of the HDMI circuitry 132). If the external display device 110 has been detected (block 320), at block 325 the embedded controller circuitry 128 enables the power loss sensing circuitry 124 and the switch circuitry 126. For example, to enable the power loss sensing circuitry 124 and the switch circuitry 126, the embedded controller circuitry 128 sets the value of its control output 172 to a second logic value (e.g., a logic-1 value), which causes the HPD input 154 of the HDMI circuitry 132 to be controlled by the power loss sensing circuitry 124 by causing the power status output 162 of the power loss sensing circuitry 124 to control the enable input 156 of the level translation circuitry 135, as described above.

At block 330, the embedded controller circuitry 128 detects whether the compute device has entered a sleep state (e.g., based on information from the BIOS of the compute device 105), as described above. If the compute device 105 has entered the sleep state, at block 335, the embedded controller circuitry 128 sets the value of its control output 172 to the first logic value (e.g., a logic-0 value) after the determination that the compute device 105 is to enter the sleep state, which causes the switch circuitry 126 to switch control of the HPD input 154 of the HDMI circuitry 132 to the HDMI_HPD line 144, thereby disabling use of the power loss sensing circuitry 124, as described above.

At block 340, the embedded controller circuitry 128 detects whether the compute device is exiting the sleep state (e.g., based on information from the BIOS of the compute device 105), as described above. If the compute device 105 is exiting the sleep state, at block 345, the embedded controller circuitry 128 waits for expiration of an enumeration time period, as described. After the time period expires (block 350), at block 355, the embedded controller circuitry 128 sets the value of its control output 172 to the second logic value (e.g., a logic-1 value), which causes the switch circuitry 126 to switch control of the HPD input 154 of the HDMI circuitry 132 the power loss sensing circuitry 124, thereby enabling the power loss sensing circuitry 124 again, as described above.

At block 360, the embedded controller circuitry 128 determines whether the compute device 105 is to power off (e.g., based on information from the OS, BIOS, etc., of the compute device 105). If the compute device 105 is not to power off (e.g., is to remain powered on), operation returns to block 330 and blocks subsequent thereto. Otherwise, the example machine-readable instructions and/or the example operations 300 end.

FIG. 4 is a flowchart representative of example machine readable instructions and/or example operations 400 that may be executed, instantiated, and/or performed by programmable circuitry to implement the example switch circuitry 126 of the display state detection circuitry 102. The example machine-readable instructions and/or the example operations 400 of FIG. 4 begin at block 405, at which the switch circuitry 126 initially asserts (e.g., sets to a value corresponding to a logic-1) its enable output, which is coupled to the enable input 156 of the level translation circuitry 135, to cause the HDMI_HPD line 144 to control the HPD input 154 of the HDMI circuitry 132, thereby disabling use of the power loss sensing circuitry 124, as described above.

At block 410, the switch circuitry 126 monitors the control output 172 of the embedded controller circuitry 128. At block 415, the switch circuitry 126 determines whether the value of the control output 172 has been changed to enable use of the power loss sensing circuitry 124 (e.g., by the control output 172 being set to a value corresponding to a logic-1 value), as described above. If the value of the control output 172 has been changed to enable use of the power loss sensing circuitry 124, at block 420, the switch circuitry 126 causes the power status output 162 of the power loss sensing circuitry 124 to set the value of the enable input 156 of the level translation circuitry 135, which results in enabling the use of the power loss sensing circuitry 124 to control the HPD input 154 of the HDMI circuitry 132, as described above.

At block 425, the switch circuitry 126 monitors the control output 172 of the embedded controller circuitry 128. At block 430, the switch circuitry 126 determines whether the value of the control output 172 has been changed to disable use of the power loss sensing circuitry 124 (e.g., by the control output 172 being set to a value corresponding to a logic-0 value), as described above. If the value of the control output 172 has been changed to disable use of the power loss sensing circuitry 124, at block 435, the switch circuitry 126 asserts the enable input 156 of the level translation circuitry 135, which causes the HDMI_HPD line 144 to control the HPD input 154 of the HDMI circuitry 132, thereby disabling the use of the power loss sensing circuitry 124, as described above.

At block 440, the switch circuitry 126 determines whether the compute device 105 is to power off (e.g., based on information from the embedded controller circuitry 128). If the compute device 105 is not to power off (e.g., is to remain powered on), operation returns to block 410 and blocks subsequent thereto. Otherwise, the example machine-readable instructions and/or the example operations 400 end.

FIG. 5 is a block diagram of an example programmable circuitry platform 500 structured to execute and/or instantiate the example machine-readable instructions and/or the example operations of FIGS. 3-4 to implement the display state detection circuitry 102 of FIGS. 1-2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the embedded controller circuitry 128 of the display state detection circuitry 102.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In the illustrated example, the interface circuitry 520 also implements the power loss sensing circuitry 124, the switch circuitry 126 and the filter 170.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 3-4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3-4 to effectively instantiate the circuitry of FIG. 2 as logic circuits to perform operations corresponding to those machine readable instructions. In some such examples, the circuitry of FIG. 1 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3-4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIGS. 3-4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-4. As such, the FPGA circuitry 700 may be configured and/or structured to effectively instantiate some or all of the operations/functions corresponding to the machine readable instructions of the flowchart(s) of FIGS. 3-4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIGS. 3-4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3-4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIGS. 3-4 to perform first operation(s)/function(s), the FPGA circuitry 700 of FIG. 7 may be configured and/or structured to perform second operation(s)/function(s) corresponding to a second portion of the machine readable instructions represented by the flowcharts of FIG. 3-4, and/or an ASIC may be configured and/or structured to perform third operation(s)/function(s) corresponding to a third portion of the machine readable instructions represented by the flowcharts of FIGS. 3-4.

It should be understood that some or all of the circuitry of FIG. 1 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 1 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

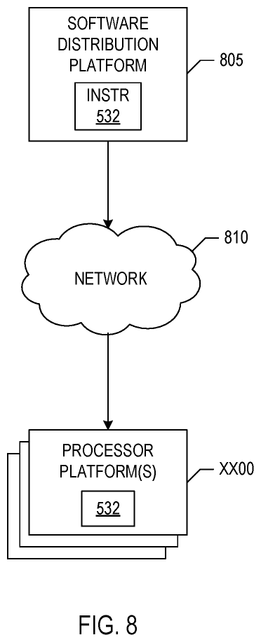

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3-4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIG. 3-4, may be downloaded to the example programmable circuitry platform 500, which is to execute the machine readable instructions 532 to implement the display state detection circuitry 102. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement external display power loss detection and sleep state recovery. Disclosed systems, apparatus, articles of manufacture, and methods improve a computing device by including hot plug detection (HPD) with power loss sensing circuitry that monitors one or more lines of the HDMI connection other than the HPD line to detect external display power loss and also support sleep state recovery. Such disclosed systems, apparatus, articles of manufacture, and methods are not susceptible to the unreliability associated with HPD when used with battery powered source compute devices operating in an active state. Moreover, such disclosed systems, apparatus, articles of manufacture, and methods are able to avoid potential race conditions that can affect the ability of some external devices to wake from their own low power states. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising first circuitry to set an output of the first circuitry to a first logic value after a determination that a compute device is to enter a sleep state, and set the output to a second logic value after a determination that the compute device is to exit the sleep state, and second circuitry to switch control of a hot plug detect (HPD) input of high-definition multimedia interface (HDMI) circuitry between an output of power loss sensing circuitry and an HPD line of an HDMI port of the HDMI circuitry based on the output of the first circuitry.

Example 2 includes the apparatus of example 1, wherein the apparatus includes the compute device.

Example 3 includes the apparatus of example 1 or example 2, wherein the power loss sense circuitry is to monitor a transmit line of the HDMI port to detect a power loss associated with a display device coupled to the HDMI port.

Example 4 includes the apparatus of any one of examples 1 to 3, wherein the first circuitry implements an embedded controller, and the output is a general purpose input output (GPIO) pin of the embedded controller.

Example 5 includes the apparatus of any one of examples 1 to 4, wherein the second circuitry has an output to couple to an enable input of level translation circuitry, the level translation circuitry having a signal input to couple to the HPD line of the HDMI port and an output to couple to the HPD input of the HDMI circuitry, the level translation circuitry to translate a first voltage range of the HPD line of the HDMI port to a second voltage range of the HPD input of the HDMI circuitry, and the second circuitry is to set a value of the enable input based on the output of the first circuitry to switch control of the HPD input of the HDMI circuitry between the output of the power loss sensing circuitry and the HPD line of the HDMI port.

Example 6 includes the apparatus of example 5, wherein the second circuitry is to assert the enable input of the level translation circuitry when the output of the first circuitry is the first logic value, and set the enable input based on the output of the power loss sensing circuitry when the output of the first circuitry is the second logic value.

Example 7 includes the apparatus of example 6, wherein the second circuitry is to assert the enable input of the level translation circuitry when the output of the power loss sensing circuitry indicates a display device coupled to the HDMI port is powered, and de-assert the enable input of the level translation circuitry when the output of the power loss sensing circuitry indicates a power loss associated with the display device.

Example 8 includes the apparatus of any one of examples 1 to 7, wherein the first circuitry is to wait to set the output to the second logic value until a time period has expired after the determination that the compute device is to exit the sleep state.

Example 9 includes the apparatus of example 8, wherein the time period is configurable.

Example 10 includes an apparatus comprising first circuitry to monitor a transmit line of a high-definition multimedia interface (HDMI) connector to detect a power loss associated with a display device coupled to the HDMI connector, and second circuitry to cause a hot plug detect (HPD) input of HDMI circuitry to be set by the first circuitry or an HPD line of the HDMI connector, the HDMI circuitry associated with the HDMI connector.

Example 11 includes the apparatus of example 10 or example 11, wherein the second circuitry is to cause the HPD input of the HDMI circuitry to be set by the first circuitry or the HPD line based on an operating state of a compute device.

Example 12 includes the apparatus of example 11, wherein the second circuitry is to cause the HPD input of the HDMI circuitry to be set by the first circuitry when the compute device is in an active state, and cause the HPD input of the HDMI circuitry to be set by the HPD line when the compute device is in a sleep state.

Example 13 includes the apparatus of example 11 or example 12, wherein the second circuitry is to switch the HPD input of the HDMI circuitry from being set by the HPD line to being set by the first circuitry after expiration of a time period after a determination that the compute device is to exit a sleep state.

Example 14 includes the apparatus of example 13, wherein the time period is configurable.

Example 15 includes the apparatus of any one of examples 11 to 14, wherein the second circuitry is to switch the HPD input of the HDMI circuitry from being set by the first circuitry to being set by the HPD line after a determination that the compute device is to enter a sleep state.

Example 16 includes at least one non-transitory computer readable storage medium comprising instructions to cause at least one processor circuit to at least set a value of an output to a first logic value after a determination that a compute device is to enter a sleep state, the output to control whether a hot plug detect (HPD) input of high-definition multimedia interface (HDMI) circuitry is set based on power loss sensing circuitry or an HPD line of an HDMI port of the HDMI circuitry, after a determination that the compute device is to exit the sleep state, wait for expiration of a time period, and set the value of the output to a second logic value after expiration of the time period.

Example 17 includes the least one non-transitory computer readable storage medium of example 16, wherein the instructions are to cause one or more of the at least one processor circuit to configure the time period.

Example 18 includes the least one non-transitory computer readable storage medium of example 16 or example 17, wherein the instructions are to cause one or more of the at least one processor circuit to configure the time period based on information from at least one of an operating system (OS) or a basic input output system (BIOS) of the compute device.

Example 19 includes the least one non-transitory computer readable storage medium of any one of examples 16 to 18, wherein the instructions are to cause one or more of the at least one processor circuit to determine the compute device is to enter the sleep state based on information from at least one of an OS or a BIOS of the compute device.

Example 20 includes the least one non-transitory computer readable storage medium of any one of examples 16 to 19, wherein the instructions are to cause one or more of the at least one processor circuit to determine the compute device is to exit the sleep state based on information from at least one of an OS or a BIOS of the compute device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
first circuitry to:
set an output of the first circuitry to a first logic value after a determination that a compute device is to enter a sleep state; and
set the output to a second logic value after a determination that the compute device is to exit the sleep state; and
second circuitry to switch control of a hot plug detect (HPD) input of high-definition multimedia interface (HDMI) circuitry between an output of power loss sensing circuitry and an HPD line of an HDMI port of the HDMI circuitry based on the output of the first circuitry.

2. The apparatus of claim 1, wherein the apparatus includes the compute device.

3. The apparatus of claim 1, wherein the power loss sense circuitry is to monitor a transmit line of the HDMI port to detect a power loss associated with a display device coupled to the HDMI port.

4. The apparatus of claim 1, wherein the first circuitry implements an embedded controller, and the output is a general purpose input output (GPIO) pin of the embedded controller.

5. The apparatus of claim 1, wherein the second circuitry has an output to couple to an enable input of level translation circuitry, the level translation circuitry having a signal input to couple to the HPD line of the HDMI port and an output to couple to the HPD input of the HDMI circuitry, the level translation circuitry to translate a first voltage range of the HPD line of the HDMI port to a second voltage range of the HPD input of the HDMI circuitry, and the second circuitry is to set a value of the enable input based on the output of the first circuitry to switch control of the HPD input of the HDMI circuitry between the output of the power loss sensing circuitry and the HPD line of the HDMI port.

6. The apparatus of claim 5, wherein the second circuitry is to:
assert the enable input of the level translation circuitry when the output of the first circuitry is the first logic value; and
set the enable input based on the output of the power loss sensing circuitry when the output of the first circuitry is the second logic value.

7. The apparatus of claim 6, wherein the second circuitry is to:
assert the enable input of the level translation circuitry when the output of the power loss sensing circuitry indicates a display device coupled to the HDMI port is powered; and
de-assert the enable input of the level translation circuitry when the output of the power loss sensing circuitry indicates a power loss associated with the display device.

8. The apparatus of claim 1, wherein the first circuitry is to wait to set the output to the second logic value until a time period has expired after the determination that the compute device is to exit the sleep state.

9. The apparatus of claim 8, wherein the time period is configurable.

10. An apparatus comprising:
first circuitry to monitor a transmit line of a high-definition multimedia interface (HDMI) connector to detect a power loss associated with a display device coupled to the HDMI connector; and
second circuitry to cause a hot plug detect (HPD) input of HDMI circuitry to be set by the first circuitry or an HPD line of the HDMI connector, the HDMI circuitry associated with the HDMI connector.

11. The apparatus of claim 10, wherein the second circuitry is to cause the HPD input of the HDMI circuitry to be set by the first circuitry or the HPD line based on an operating state of a compute device.

12. The apparatus of claim 11, wherein the second circuitry is to:
cause the HPD input of the HDMI circuitry to be set by the first circuitry when the compute device is in an active state; and
cause the HPD input of the HDMI circuitry to be set by the HPD line when the compute device is in a sleep state.

13. The apparatus of claim 11, wherein the second circuitry is to switch the HPD input of the HDMI circuitry from being set by the HPD line to being set by the first circuitry after expiration of a time period after a determination that the compute device is to exit a sleep state.

14. The apparatus of claim 13, wherein the time period is configurable.

15. The apparatus of claim 11, wherein the second circuitry is to switch the HPD input of the HDMI circuitry from being set by the first circuitry to being set by the HPD line after a determination that the compute device is to enter a sleep state.

16. At least one non-transitory computer readable storage medium comprising instructions to cause at least one processor circuit to at least:
set a value of an output to a first logic value after a determination that a compute device is to enter a sleep state, the output to control whether a hot plug detect (HPD) input of high-definition multimedia interface (HDMI) circuitry is set based on power loss sensing circuitry or an HPD line of an HDMI port of the HDMI circuitry;
after a determination that the compute device is to exit the sleep state, wait for expiration of a time period; and
set the value of the output to a second logic value after expiration of the time period.

17. The least one non-transitory computer readable storage medium of claim 16, wherein the instructions are to cause one or more of the at least one processor circuit to configure the time period.

18. The least one non-transitory computer readable storage medium of claim 16, wherein the instructions are to cause one or more of the at least one processor circuit to configure the time period based on information from at least one of an operating system (OS) or a basic input output system (BIOS) of the compute device.

19. The least one non-transitory computer readable storage medium of claim 16, wherein the instructions are to cause one or more of the at least one processor circuit to determine the compute device is to enter the sleep state based on information from at least one of an OS or a BIOS of the compute device.

20. The least one non-transitory computer readable storage medium of claim 16, wherein the instructions are to cause one or more of the at least one processor circuit to determine the compute device is to exit the sleep state based on information from at least one of an OS or a BIOS of the compute device.
